(19) United States
(12) Patent Application Publication
(10) Pub. No.: US 2013/0021351 A1
(43) Pub. Date: Jan. 24, 2013

(54) METHOD AND SYSTEM FOR CONTROLLING MULTIMEDIA MONITOR

(71) Applicants: Feng-Yuan Chen, New Taipei City (TW); Kang-Ming Peng, New Taipei City (TW)

(72) Inventors: Feng-Yuan Chen, New Taipei City (TW); Kang-Ming Peng, New Taipei City (TW)

(73) Assignee: WISTRON CORPORATION, New Taipei City (TW)

(21) Appl. No.: 13/239,368

(22) Filed: Sep. 21, 2011

(30) Foreign Application Priority Data
Jul. 22, 2011 (TW) 100126015

(51) Int. Cl. G06T 1/00; G06F 13/14

(52) U.S. Cl. 345/519; 345/522

(57) ABSTRACT

A method and a system for controlling a multimedia monitor are provided. The multimedia monitor has a central processing unit (CPU) and communicates with a computer system through a communication interface. The multimedia monitor displays images from the computer system when the multimedia monitor is in an external signal mode, and displays images generated by the CPU when the multimedia monitor is in a multimedia application mode. In the method, an input event is received by the computer system and an input command corresponding to the input event is transmitted to the multimedia monitor through the communication interface. After that, whether the input command belongs to a multimedia command set is determined by the multimedia monitor. If the input command belongs to the multimedia command set, an action corresponding to the input command under the multimedia application mode is executed by the multimedia monitor.

### CROSS-REFERENCE TO RELATED APPLICATION

This application claims the priority benefit of Taiwan application serial no. 100126015, filed on Jul. 22, 2011. The entirety of the above-mentioned patent application is hereby incorporated by reference herein and made a part of this specification.

### BACKGROUND OF THE INVENTION

1. Field of the Invention

The invention relates to an application of a multimedia monitor. Particularly, the invention relates to a method and a system for controlling a multimedia monitor.

2. Description of Related Art

With development of technology, monitors simply used for displaying images cannot satisfy consumer's demand, so that multimedia functions such as Internet accessing are developed for the conventional monitor, and the monitor can be connected to an external computer through a video cable to display images from the external computer. Multimedia monitors having the above functions gradually draw consumer's attention.

Generally, according to different image sources, the multimedia monitors generally have two modes of an external signal mode and a multimedia application mode. In the external signal mode, the multimedia monitor displays images received from the external computer, and a user can control an operating system and application programs of the external computer through an input device such as a keyboard or a mouse of the external computer. However, once the user wants to use a multimedia function of the multimedia monitor, the user has to switch the multimedia monitor to the multimedia application mode. At this time, the multimedia monitor displays images produced by a central processing unit (CPU) therein. The user has to connect an additional input device to the multimedia monitor in order to operate an operating system and application programs of the multimedia monitor through the input device.

Therefore, when the user operates the external computer and the multimedia monitor, two sets of input devices are used, which may cause inconvenience in utilization. Moreover, the additional input device also requires additional cost.

### SUMMARY OF THE INVENTION

Accordingly, the invention is directed to a method and a system for controlling a multimedia monitor, by which a user is capable of operating the multimedia monitor in a multimedia application mode without connecting an additional input device to the multimedia monitor.

The invention provides a method for controlling a multimedia monitor, and the multimedia monitor has a central processing unit (CPU) and communicates with a computer system through a communication interface. The multimedia monitor displays images received from the computer system when the multimedia monitor is in an external signal mode, and displays images generated by the CPU when the multimedia monitor is in a multimedia application mode. In the method, an input event is received by the computer system and an input command corresponding to the input event is transmitted to the multimedia monitor through the communication interface. After that, whether the input command belongs to a multimedia command set is determined by the multimedia monitor. When the input command belongs to the multimedia command set, an action corresponding to the input command under the multimedia application mode is executed by the multimedia monitor.

In an embodiment of the invention, after the step of receiving the input event by the computer system, the method for controlling the multimedia monitor further includes identifying a type of the input event by the computer system, and converting the input event into the corresponding input command according to the type of the input event.

In an embodiment of the invention, the step of transmitting the input command to the multimedia monitor through the communication interface includes obtaining a specific pin of the communication interface, and transmitting the input command to the multimedia monitor through the specific pin.

In an embodiment of the invention, the specific pin complies with an inter-integrated circuit (I²C) communication protocol.

In an embodiment of the invention, after the step of determining whether the input command belongs to the multimedia command set by the multimedia monitor, the method for controlling the multimedia monitor further includes adjusting a monitor setting value by the multimedia monitor according to the input command when the input command does not belong to the multimedia command set.

In an embodiment of the invention, the step of executing the action under the multimedia application mode by the multimedia monitor according to the input command includes identifying a type of the input command, converting the input command into the corresponding input event according to the type of the input command, and executing the action under the multimedia application mode according to the input event.

According to another aspect, the invention provides a system for controlling a multimedia monitor. The system includes a computer system and the multimedia monitor. The computer system includes an input device, an event converting module and a computer connector. The input device is used for generating an input event. The event converting module is coupled to the input device for converting the input event into a corresponding input command. The computer connector is coupled to the event converting module for sending the input command. The multimedia monitor has an external signal mode and a multimedia application mode, and includes a monitor connector, a central processing unit (CPU), a display unit, a control unit and a filtering module. The monitor connector is coupled to the computer connector to establish a communication interface between the computer system and the multimedia monitor. The control unit is coupled to the monitor connector, the CPU and the display unit. The control unit controls the display unit to display images from the computer system when the multimedia monitor is in the external signal mode, and controls the display unit to display images generated by the CPU when the multimedia monitor is in the multimedia application mode. The filtering module is coupled to the monitor connector, the control unit and the CPU. The filtering module receives the input command from the computer system through the communication interface, and determines whether the input command belongs to a multimedia command set. When the input command belongs to the multimedia command set, the filtering module notifies the CPU to execute an action corresponding to the input command under the multimedia application mode.

In an embodiment of the invention, the event converting module identifies a type of the input event, and converts the input event into the corresponding input command according to the type of the input event.

In an embodiment of the invention, the input command is transmitted through a specific pin of the respective computer connector and the monitor connector.

In an embodiment of the invention, the specific pin complies with an I²C communication protocol.

In an embodiment of the invention, when the filtering module determines that the input command does not belong to the multimedia command set, it transmits the input command to the control unit, and the control unit adjusts a monitor setting value of the display unit according to the input command.

In an embodiment of the invention, the multimedia monitor further includes a command converting module coupled between the CPU and the filtering module. After the command converting module receives the input command from the filtering module, the command converting module identifies a type of the input command, and converts the input command into the corresponding input event according to the type of the input command, and transmits the input event to the CPU, and the CPU executes the action under the multimedia application mode according to the input event.

According to the above descriptions, in the invention, the computer system connected to the multimedia monitor is used to receive the input event, and the input command corresponding to the input event is transmitted to the multimedia monitor through the specific pin in the communication interface, so as to control the multimedia monitor to execute the corresponding action. In this way, even if the multimedia monitor is in the multimedia application mode, the user can still operate the multimedia monitor through the computer system connected to the multimedia monitor without connecting an additional input device to the multimedia monitor.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a control system of a multimedia monitor according to an embodiment of the invention.

FIG. 2 is a flowchart illustrating a method for controlling a multimedia monitor according to an embodiment of the invention.

FIG. 3 is a flowchart illustrating a method for controlling a multimedia monitor according to another embodiment of the invention.

### DETAILED DESCRIPTION OF DISCLOSED EMBODIMENTS

Regarding a multimedia monitor having an external signal mode and a multimedia application mode, in order to avoid a situation that a user has to connect an additional input device to operate the multimedia monitor when the multimedia monitor is in the multimedia application mode, the invention provides a method and a system for controlling the multimedia monitor, by which a computer system connected to the multimedia monitor is used to operate the multimedia monitor in the multimedia application mode. Plural embodiments are provides below to describe the invention in detail.

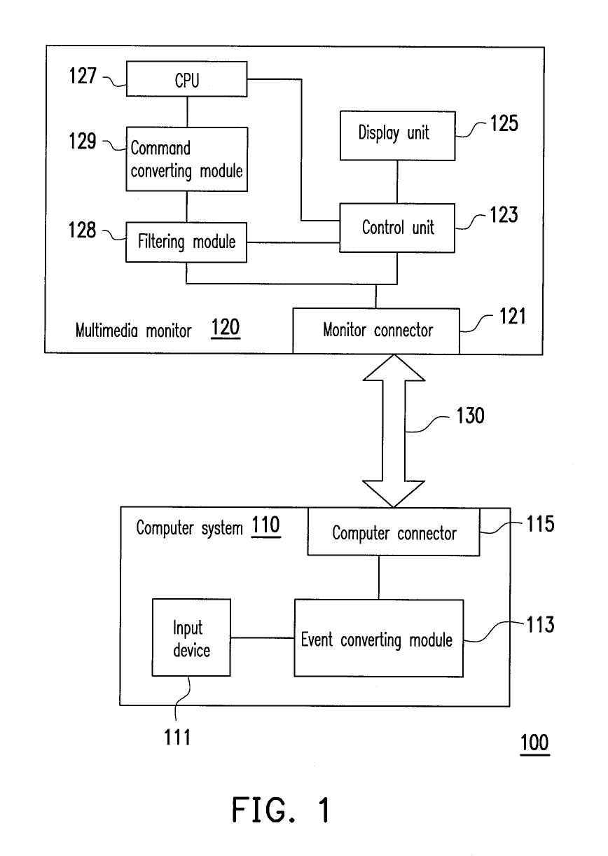

FIG. 1 is a schematic diagram of a control system of a multimedia monitor according to an embodiment of the invention. Referring to FIG. 1, the control system 100 includes a computer system 110 and a multimedia monitor 120.

In the present embodiment, the computer system 110 may be a tablet personal computer system or a desktop computer system, though a type of the computer system 110 is not to limit the scope of the invention. As shown in FIG. 1, the computer system 110 includes an input device 111, an event converting module 113 and a computer connector 115.

The input device 111 is, for example, a mouse, a keyboard, a joy stick, a touch pad or a touch screen, etc., which is used for generating an input event according to an operation of the user.

The computer connector 115 may support a video graphics array (VGA) specification, a digital visual interface (DVI) specification or a high-definition multimedia interface (HDMI) specification. A video cable having a specification corresponding to that of the computer connector 115 can be used to connect the computer system 110 to other devices.

The event converting module 113 is coupled to the input device 111 and the computer connector 115. The event converting module 113 may be implemented by a hardware device such as a logic gate, etc., computer software, or a combination of the hardware device and the computer software. For example, if the event converting module 113 is implemented as an application program, the application program can be stored in a storage unit (for example, a memory, which is not shown) of the computer system 110, and a central processing unit (CPU) (not shown) of the computer system 110 executes the application program to implement a function of the event converting module 113. Detailed function of the event converting module 113 is described later.

The multimedia monitor 120 includes a monitor connector 121, a control unit 123, a display unit 125, a CPU 127, a filtering module 128 and a command converting module 129. The control unit 123 is coupled to the monitor connector 121, the display unit 125, the CPU 127 and the filtering module 128. Moreover, the filtering module 128 is also connected to the monitor connector 121, and the command converting module 129 is coupled between the CPU 127 and the filtering module 128.

In the present embodiment, the monitor connector 121 supports the same interface specifications as that of the commuter connector 115, for example, supports the VGA specification, the DVI specification or the HDMI specification. A video cable having the corresponding specification can be used to connect the monitor connector 121 and the computer connector 115 to establish a communication interface 130 (i.e. an image output interface) between the computer system 110 and the multimedia monitor 120. The computer system 110 and the multimedia monitor 120 can transmit data to each other through the communication interface 130.

The display unit 125 may be a liquid crystal display used for displaying images. In detail, when the multimedia monitor 120 is in the external signal mode, the control unit 123 receives signals from the computer system 110 through the monitor connector 121 and the communication interface 130, and controls the display unit 125 to display images received from the computer system 110. When the multimedia monitor 120 is in the multimedia application mode, the control unit 123 receives images produced by the CPU 127, and controls the display unit 125 to display the images.

The filtering module 128 and the command converting module 129 may be implemented by hardware devices such as logic gates, etc., computer software, or a combination of the hardware device and the computer software. For example, if the command converting module 129 is implemented as an application program, the application program may be stored in a storage unit (for example, a memory, which is not shown) of the multimedia monitor 120, and the CPU 127 of the multimedia monitor 120 executes the application program to implement a function of the command converting module 129. Detailed function of the filtering module 128 and the command converting module 129 are described later.

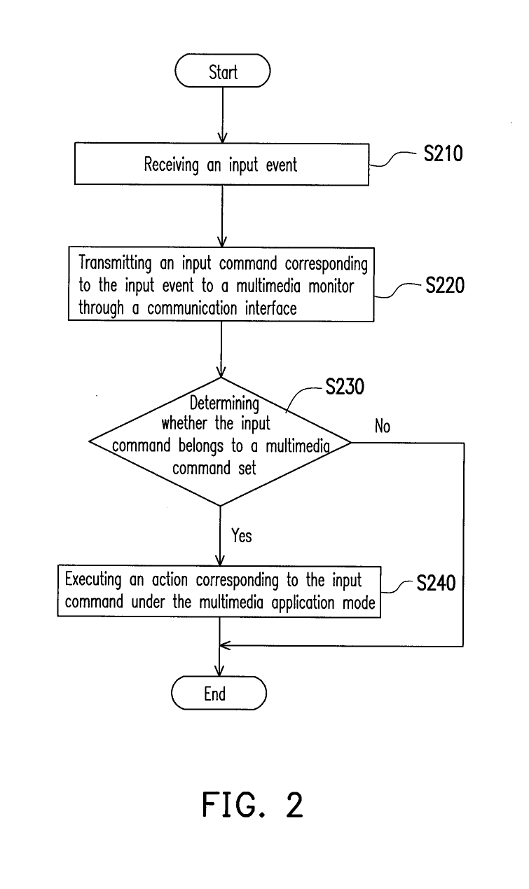

To further describe detailed operations of the control system 100, another embodiment is provided below for descriptions. FIG. 2 is a flowchart illustrating a method for controlling a multimedia monitor according to an embodiment of the invention. Referring to FIG. 1 and FIG. 2, in the present embodiment, the monitor connector 121 has been connected to the computer connector 115 through the video cable. In other words, the communication interface 130 capable of transmitting data is established between the computer system 110 and the multimedia monitor 120.

First, in step S210, when the user operates the input device 111 of the computer system 110, the computer system 110 receives a corresponding input event.

The, in step S220, the computer system 110 transmits an input command corresponding to the input event to the monitor connector 121 of the multimedia monitor 120 through the computer connector 115 and the communication interface 130. In detail, specific pins of the respective computer connector 115 and the monitor connector 121 are used to transmit and receive the input command, and the specific pins comply with an inter-integrated circuit (I²C) communication protocol. For example, if the computer connector 115 and the monitor connector 121 are complied with the VGA specification, the specific pins may be pins with referential numbers of 12 and 15. If the computer connector 115 and the monitor connector 121 are complied with the DVI specification, the specific pins may be pins with referential numbers of 6 and 7. If the computer connector 115 and the monitor connector 121 are complied with the HDMI specification, the specific pins may be pins with referential numbers of 15 and 16.

Generally, the specific pin in the communication interface is used for transmitting commands used for adjusting a monitor setting value, for example, a monitor control command set (MCCS), which is used for adjusting a setting value such as brightness or contrast of the display unit 125. Therefore, after the multimedia monitor 120 receives the input command from the computer system 110, in order to avoid an error action, in step S230, the filtering module 128 of the multimedia monitor 120 determines whether the input command belongs to a predetermined multimedia command set (including a mapping relationship between multimedia application commands and actions executed under the multimedia application mode). For example, the filtering module 128 identifies whether the received input command belongs to the multimedia command set or belongs to the MCCS by analysing the communication protocol.

If the filtering module 128 determines that the input command belongs to the multimedia command set, in step S240, the CPU 127 executes an action corresponding to the input command under the multimedia application mode. The action is, for example, to control the operating system or the application program of the multimedia monitor 120 to play music or a movie, etc., which is not to limit the scope of the invention.

As described above, since the computer system 110 has the input device 111 itself, according to the method for controlling the multimedia monitor of FIG. 2, the user can use the input device 111 of the computer system 110 to control the multimedia monitor 120 to execute actions under the multimedia application mode. In other words, the user is able to operate the multimedia monitor 120 through the computer system 110 without connecting an additional input device and using additional wire when the multimedia monitor 120 is switched to the multimedia application mode.

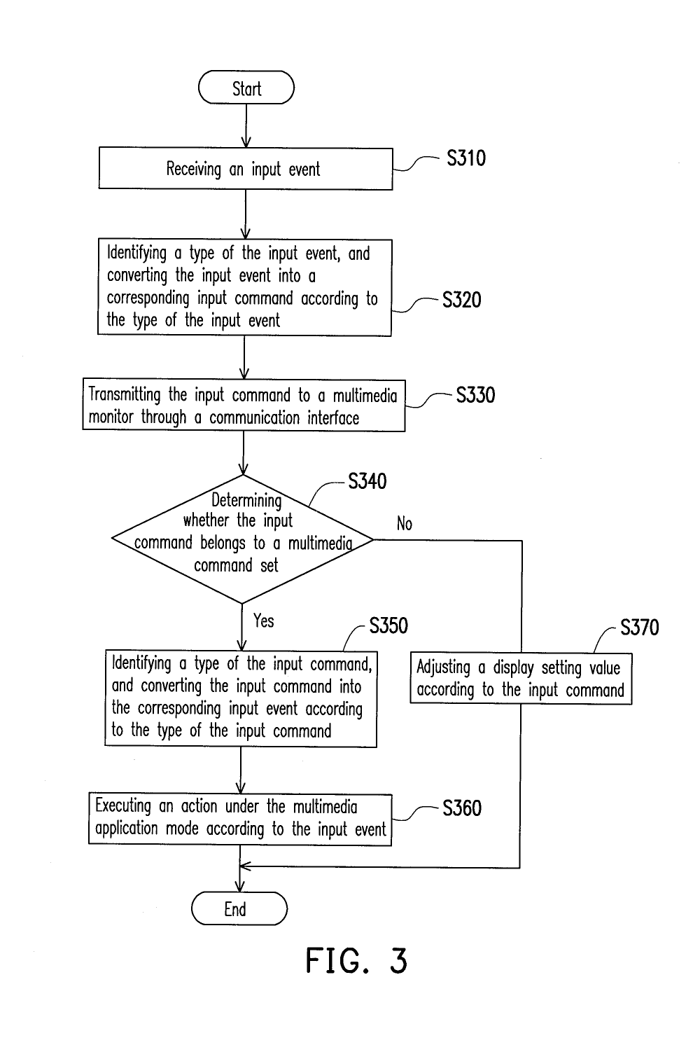

FIG. 3 is a flowchart illustrating a method for controlling a multimedia monitor according to another embodiment of the invention.

Referring to FIG. 1 and FIG. 3, when the user operates the input device 111 of the computer system 110, in step S310, the event converting module 113 in the computer system 110 receives an input event generated by the input device 111. In step S320, the event converting module 113 identifies a type of the input event, and converts the input event into a corresponding input command according to the type of the input event. In detail, the event converting module 113 first determines whether the control system 100 of the multimedia monitor supports the input event. For example, if the control system 100 of the multimedia monitor only supports the input event generated by a keyboard or a mouse, the event converting module 113 determines whether the input event is triggered by the keyboard or the mouse, and if yes, the event converting module 113 converts the input event into the corresponding input command according to the type of the input event by, for example, querying a look-up table.

Then, in step S330, the computer connector 115 transmits the input command generated by the event converting module 113 to the monitor connector 121 of the multimedia monitor 120 through the communication interface 130. In the present embodiment, when the input command is transmitted, the specific pin (complied with the I²C communication protocol) of the communication interface is first obtained according to the specification of the communication interface, and then the specific pins of the computer connector 115 and the monitor connector 121 are used to transmit and receive the input command.

After the input command is transmitted to the multimedia monitor 120, in step S340, the filtering module 128 determines whether the input command belongs to the multimedia command set. The filtering module 128 may perform the determination by analysing the communication protocol.

If the filtering module 128 determines that the input command belongs to the multimedia command set, in step S350, the filtering module 128 transmits the input command to the command converting module 129, and the command converting module 129 identifies a type of the input command, and converts the input command into the corresponding input event according to the type of the input command by querying the look-up table, and then transmits the input event to the CPU 127. Finally, in step S360, when the multimedia monitor 120 is in the multimedia application mode, the CPU 127 executes an action according to the input event.

Referring back to the step S340 of FIG. 3, if the filtering module 128 determines that the input command does not belong to the multimedia application set, the filtering module 128 transmits the input command to the control unit 123, and in step S370, the control unit 123 adjusts the display setting value according to the input command, for example, adjusts the brightness or the contrast, etc. of the display unit 125.

In the aforementioned embodiment, after the monitor connector 121 is connected to the computer connector 115 through the video cable to establish the communication interface 130 between the computer system 110 and the multimedia monitor 120, if the multimedia monitor 120 is switched to the multimedia application mode, and the user uses the input device 110 (for example, the keyboard) of the computer system 110 to input an English letter K, after the event converting module 113 confirms that the control system 100 supports the input event corresponding to the English level K, it converts the input event into an input command, and transmits the input command to the multimedia monitor 120 through the specific pin in the communication interface 130 that is complied with the I²C communication protocol. After the filtering module 128 in the multimedia monitor 120 confirms that the input command belongs to the multimedia command set, the command converting module 129 restores the input command into the input event corresponding to the English letter K, and then the CPU 127 executes a corresponding action according to the input event.

It should be noticed that in the other embodiments of the invention, the computer system 110 may be any external device having an input device, an event converting module and a connector complied with a specific specification (for example, a connector complied with the VGA specification, the DVI specification or the HDMI specification). After the external device is connected to the multimedia monitor 120, commands may be transmitted to the multimedia monitor 120 through the specific pin of the communication interface that is complied with the I²C communication protocol according to operations of the user on the input device, so as to control the CPU 127 of the multimedia monitor 120 to execute corresponding actions.

In summary, according to the method and the system for controlling the multimedia monitor of the invention, the user is able to control devices of the multimedia monitor through the computer system without adding a connection wire between the multimedia monitor and the computer system and adding an additional input device to the multimedia monitor. In this way, even if the user switches the multimedia monitor from the external signal mode to the multimedia application mode, the user can still control the multimedia monitor to execute actions of the multimedia application mode through the input device of the computer system. Therefore, cost for adding the input device is saved, and inconvenience of switching different input devices is mitigated.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for controlling a multimedia monitor, wherein the multimedia monitor has a central processing unit (CPU) and communicates with a computer system through a communication interface, the multimedia monitor displays images received from the computer system when the multimedia monitor is in an external signal mode, and displays images generated by the CPU when the multimedia monitor is in a multimedia application mode, the method for controlling the multimedia monitor comprising:
receiving an input event by the computer system;
transmitting an input command corresponding to the input event to the multimedia monitor by the computer system through the communication interface;
determining whether the input command belongs to a multimedia command set by the multimedia monitor; and
executing an action corresponding to the input command under the multimedia application mode by the multimedia monitor when the input command belongs to the multimedia command set.

2. The method for controlling the multimedia monitor as claimed in claim 1, wherein after the step of receiving the input event by the computer system, the method for controlling the multimedia monitor further comprises:
identifying a type of the input event by the computer system; and
converting the input event into the corresponding input command according to the type of the input event.

3. The method for controlling the multimedia monitor as claimed in claim 1, wherein the step of transmitting the input command to the multimedia monitor by the computer system through the communication interface comprises:
obtaining a specific pin of the communication interface; and
transmitting the input command to the multimedia monitor through the specific pin.

4. The method for controlling the multimedia monitor as claimed in claim 3, wherein the specific pin complies with an inter-integrated circuit (I²C) communication protocol.

5. The method for controlling the multimedia monitor as claimed in claim 1, wherein after the step of determining whether the input command belongs to the multimedia command set by the multimedia monitor, the method for controlling the multimedia monitor further comprises:
adjusting a monitor setting value by the multimedia monitor according to the input command when the input command does not belong to the multimedia command set.

6. The method for controlling the multimedia monitor as claimed in claim 1, wherein the step of executing the action under the multimedia application mode by the multimedia monitor according to the input command comprises:
identifying a type of the input command;
converting the input command into the corresponding input event according to the type of the input command; and
executing the action under the multimedia application mode according to the input event.

7. A system for controlling a multimedia monitor, comprising:
a computer system, comprising:
an input device, generating an input event;
an event converting module, coupled to the input device, for converting the input event into a corresponding input command; and
a computer connector, coupled to the event converting module, for sending the input command; and
the multimedia monitor, having an external signal mode and a multimedia application mode, and comprising:
a monitor connector, coupled to the computer connector to establish a communication interface between the computer system and the multimedia monitor;
a central processing unit (CPU),
a display unit,
a control unit, coupled to the monitor connector, the CPU and the display unit, wherein the control unit controls the display unit to display images from the computer system when the multimedia monitor is in the external signal mode, and controls the display unit to display images generated by the CPU when the multimedia monitor is in the multimedia application mode; and
a filtering module, coupled to the monitor connector, the control unit and the CPU, wherein the filtering module receives the input command from the computer system through the communication interface, and determines whether the input command belongs to a multimedia command set,
wherein when the input command belongs to the multimedia command set, the filtering module notifies the CPU to execute an action corresponding to the input command under the multimedia application mode.

8. The system for controlling a multimedia monitor as claimed in claim 7, wherein the event converting module identifies a type of the input event, and converts the input event into the corresponding input command according to the type of the input event.

9. The system for controlling a multimedia monitor as claimed in claim 7, wherein the input command is transmitted through a specific pin of the respective computer connector and the monitor connector.

10. The system for controlling a multimedia monitor as claimed in claim 9, wherein the specific pin complies with an I²C communication protocol.

11. The system for controlling a multimedia monitor as claimed in claim 7, wherein when the filtering module determines that the input command does not belong to the multimedia command set, it transmits the input command to the control unit, and the control unit adjusts a monitor setting value of the display unit according to the input command.

12. The system for controlling a multimedia monitor as claimed in claim 7, wherein the multimedia monitor further comprises:
a command converting module, coupled between the CPU and the filtering module, wherein after the command converting module receives the input command from the filtering module, the command converting module identifies a type of the input command, converts the input command into the corresponding input event according to the type of the input command, and transmits the input event to the CPU, and the CPU executes the action under the multimedia application mode according to the input event.
